(19) United States
(12) Patent Application Publication
(10) Pub. No.: US 2002/0175990 A1
(43) Pub. Date: Nov. 28, 2002

(54) MIRROR BASED INTERFACE FOR COMPUTER VISION APPLICATIONS

(76) Inventors: JACQUELYN ANNETTE MARTINO, COLD SPRING, NY (US); DAMIAN M. LYONS, PUTNAM VALLEY, NY (US); KAREN I. TROVATO, PUTNAM VALLEY, NY (US)

Correspondence Address: US PHILIPS CORPORATION, CORPARTE PATENT COUNSEL, 580 WHITE PLAINS RD, TARRYTOWN, NY, 10591

(21) Appl. No.: 09/282,320

(22) Filed: Mar. 31, 1999

(51) Int. Cl. H04N 7/14

(52) U.S. Cl. 348/14.08; 348/14.01

(57) ABSTRACT

To facilitate the framing of an image in a camera's field of view, a mirror system is provided that has a field of reflection that corresponds substantially to the field of view of the camera. If a target person can see his or her reflection in the mirror, the target person is assured that a substantially similar image is being seen by the camera. This invention also includes an integration of the mirror-camera framing system with computer vision applications, such as a teleconferencing system, a recognition system, a broadcast system, and a messaging system with attached images for personalization and authentication. The use of a mirror for image feedback allows the invention to be embodied in a small low powered device, such as a watch, pendant, or portable telephone.

### BACKGROUND OF THE INVENTION

1. Field of the Invention

This invention relates to the field of computers, and in particular to the field of computer vision.

2. Description of Related Art

The use of cameras in computer systems, commonly termed computer vision, continues to increase. Video conferencing, “live feeds”, and the like are common applications that require computer vision, and advanced user interfaces that use computer vision are becoming increasing available for desktop, home, and mobile computing devices. Conventional camera applications involve the use of a camera operator who controls the camera, and, in particular, controls the image that the camera records by appropriately orienting the camera. The camera operator may also provide direction to improve the appearance of the objects being recorded. In the terminology common to the field, proper image framing assures that a desired image is included within the field of view of the camera.

A typical computer vision application is often operated using a fixed position camera, and no camera operator per se. One of the difficulties associated with camera operations without a camera operator is keeping the targeted person in view of the camera. If the target person is given appropriate feedback, the person can modify his or her position, or modify the camera orientation, so that the camera's field of view includes the person. Another problem with an unattended camera is the lack of feedback to the person as to how they appear to the camera.

Conventionally, proper image framing in an environment that lacks a camera operator is effected by providing the image from the camera to an output device, such as a video screen, that is within view of the target person. The target person views the video screen and adjusts his or her position accordingly to appropriately frame his or her image on the video screen. The video screen, or a device to interface the camera to an existing screen, however, adds cost to each computer video system. To reduce the cost, alternative systems provide a simpler indication, such as a light or a set of lights, that indicates whether a person is within the field of view of the camera. Although such solutions address the image framing problem, they do not provide the person with a view of their appearance to the camera.

The conventional use of a feedback display screen also imposes a size and power requirement that limits the potential applications for video input. As video conferencing, and video phones in general, become commonplace, the demand for small and portable camera devices, such as a camera within a wrist watch, or in a cellular phone, can be expected to increase.

### BRIEF SUMMARY OF THE INVENTION

It is an object of this invention to provide a low cost system for framing a camera image. It is a further object of this invention to provide the object of the camera image with a view that corresponds substantially to the view seen by the camera. It is a further object of this invention to provide a low cost video transmission system. It is a further object of this invention to provide a small and portable video input system. It is a further object of this invention to provide a video input system that is simple enough to allow a computer vision interface to any electronic device. It is a further object of this invention to provide a video input systems that enhances the privacy, security, and personalization of computer devices.

These object and others are achieved by providing an integrated camera and mirror system that has a field of reflection from the mirror that corresponds substantially to the field of view of the camera. If a target person can see his or her reflection in the mirror, the target person is assured that a substantially similar image is being seen by the camera. This invention also includes an integration of the mirror-camera framing system with computer video applications, such as a teleconferencing system, a recognition system, and a broadcast system, as well as other applications that are not conventionally video-enabled, such as PDAs (Personal Data Assistants) and portable telephones. The invention is applicable to video camera systems, motion picture systems, photographic systems (still and motion), and other means of image capture.

### BRIEF DESCRIPTION OF THE DRAWINGS

The invention is explained in further detail, and by way of example, with reference to the accompanying drawings wherein:

FIG. 1 illustrates an example image framing system in accordance with this invention.

FIGS. 2A, 2B, and 2C illustrate examples of alternative embodiments of the image framing system in accordance with this invention.

FIGS. 3A and 3B illustrate examples of alternative embodiments of a video system in accordance with this invention.

FIG. 4 illustrates an example video recognition system in accordance with this invention.

FIGS. 5A and 5B illustrate examples of alternative embodiments of integrated video systems in accordance with this invention.

FIGS. 6A and 6B illustrate example embodiments of an image framing system for cameras with variable fields of view, in accordance with this invention.

FIGS. 7A and 7B illustrate example alternative embodiments of an image framing system for cameras with variable fields of view, in accordance with this invention.

FIGS. 8A and 8B illustrate further example alternative embodiments of an image framing system for cameras with variable fields of view, in accordance with this invention.

### DETAILED DESCRIPTION OF THE INVENTION

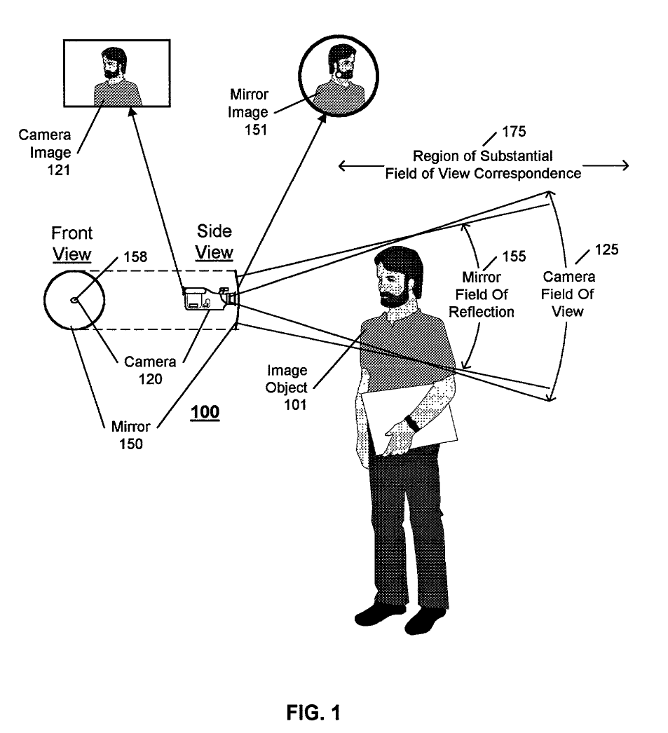

FIG. 1 illustrates an example image framing system 100 that includes a camera 120 and a mirror 150. The mirror 150 in this example has a transparent center area 158, through which the camera 120 receives image information. The camera 120 has a field of view 125; the camera 120 receives image information from objects 101 within its field of view 125. The term “camera” 120 is used herein as a device that produces an output 121 in dependence upon light received from an object within its field of view 125. Different applications will require different light detecting ability from the camera 120, ranging from a mere detection of an object's presence to an accurate portrayal of the object in very fine detail. If an object is not within the field of view 125 of the camera 120, the camera image 121 will not include the object. The characteristics of the lens (not shown) of the camera 120, and the orientation of the camera 120, determines its field of view 125.

The mirror 150 has a field of reflection 155. An object 101 within the field of reflection 155 of the mirror 1 50 will see its reflection 151. If an object is not within the field of reflection 155 of the mirror 150, the mirror image 151, as seen by the object, will not include the object. The shape, size, and orientation of the mirror 150 determines its field of reflection 155.

In accordance with this invention, the size, shape, and/or orientation of the mirror 150 is structured to produce a field of reflection 155 that substantially corresponds to the field of view 125 of the camera 120. To ease the complexity of aligning these fields 125, 155, the fields need not correspond exactly, and need not correspond at all distances from the camera 120. That is, in general, there is a certain region 175 within which the fields should correspond substantially, as determined by the particular application and use of the camera 120. If the camera 120 and the object 101 are very close to each other, the portions of the object, if any, that are within the field of view 125 of the camera 120 is usually fairly apparent. Thus, the field of reflection 155 and the field of view 125 need not correspond in the immediate vicinity of the camera 120 and mirror 150. If the camera 120 and the object 101 are separated by a great distance, the use of visual feedback to frame the image is not generally feasible, due to limitations of the human visual system. Thus, beyond some predetermined distance, the fields need not correspond. Also, in many applications, the object 101 and camera 120 are confined to a given area, such as a room or studio. The confining area imposes a limit to the extent of the camera's field of view 125 and the mirror's field of reflection 155, and thus allows a limit to the extent of the region 175 in which the fields 125, 155 must substantially correspond. In general terms, the region 175 in which the fields 125, 155 should substantially correspond is the region from two feet to thirty feet from the camera, although different applications may allow or require different bounds.

As illustrated in FIG. 1, by an appropriate configuration of the mirror 150 and the camera 120, the mirror image 151, as seen by the image object 101, substantially corresponds to the camera image 121, except, obviously, in mirror-image form. If the image object 101 changes position, his mirror image 151 will change, as will his camera image 121. If and when the image object 101 notices that he no longer appears in the mirror image 151, he will also realize that it is very likely that he no longer appears in the camera image 121, and can adjust his position accordingly. Note that, in accordance with this invention, the correspondence between the mirror image 151 and the camera image 121 need not include a correspondence in resolution. For example, the mirror image 151 will typically be a recognizable reproduction of the objects within its field of reflection, even if the camera 120 is a very low resolution device. Conversely, a high quality glass lens camera 120 may be used to capture very detailed camera images 121, while an inexpensive piece of reflective Mylar may be sufficient to reflect a blurred mirror image 151 that is suitable for framing the image object 101 in the detailed camera image 121.

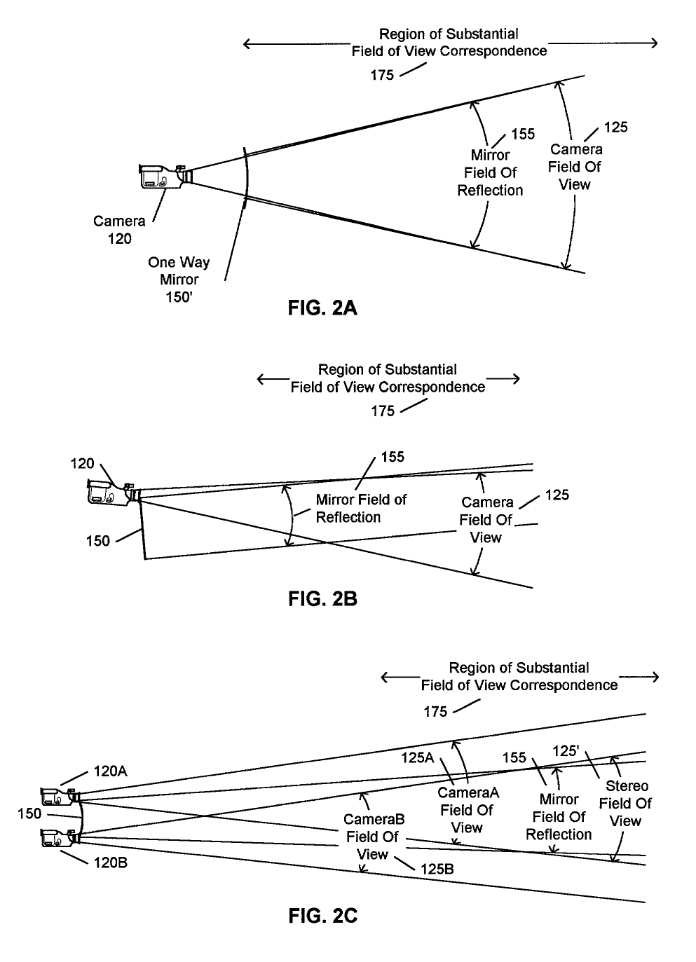

The degree of correspondence in this region 175 need not be symmetric nor uniform. For example, the clipping of a person's forehead from the top of the image is typically more visually disturbing than the clipping of a person's feet from the bottom of the image, and thus the field of reflection and field of view may by aligned such that there is a high degree of correspondence along the upper extent of the fields 125, 155, but a lesser degree at the lower extents. FIG. 2B, discussed further, illustrates such a correspondence. In like manner, the size of each field 125, 155 need not be similar. In FIG. 1, for example, the camera image 121 illustrates a rectangular shape to the field of view 125 of the camera 120, while the mirror image 151 illustrates a circular shape to the field of reflection 155 of the mirror 150. In this example, the area in the center of the camera image 121 is the area in which the field of view 125 and field of reflection 155 substantially correspond. Similarly, the mirror 150 could be constructed to have a small field of reflection 155 that substantially corresponds to the field of view 125 only in a small center area of the field of view 125. In general terms, the fields 125, 155 should correspond to an extent necessary for the user of the system to be able to determine whether a change of position is warranted to increase the likelihood of being appropriately situated within the camera's field of view. In a preferred embodiment, the field of reflection 155 is structured to provide a mirror image 151 that provides a fair representation of the view seen by the camera 120. Thus, as illustrated in FIG. 1, the surface of the mirror 150 is curved to more accurately depict a mirror image 151 that corresponds to the camera image 121 than that depicted by a flat mirror. As would be evident to one of ordinary skill in the art, a flat mirror 150 would provide a field of reflection 155 that would substantially correspond to the camera field of view 125 in the center of the camera image 121 only, but in general would be less costly to produce. The use of a flat mirror 150 is discussed further with regard to FIG. 2B.

FIGS. 2A-2C illustrate examples of alternative embodiments of the image framing system 100 in accordance with this invention. In the figures, items having similar function as items in other figures are identified with the same reference numeral. In FIG. 2A, a one-way mirror 150′ is used in lieu of the mirror 150 in FIG. I that contained a center transparent area 158. The one-way mirror 150′ is reflective to objects within its field of reflection 155, but transparent to objects on the opposite side of the mirror 150 from its field of reflection 155. That is, in FIG. 2A, the camera 120 is on the opposite side of the mirror 150 from the mirror's field of reflection 155, and from this side, the mirror 150 is transparent. Thus, the camera's field of view 125 extends through the mirror 150. As can be seen in FIG. 2A, the use of a curved one way mirror 150′ allows for the structuring of a field of reflection 155 that substantially corresponds to the field of view 125 for objects both close to the mirror 150, as well as distanced from the mirror 150.

In FIG. 2B, an example use of a flat mirror 150 that is adjacent the camera 120 is illustrated. To provide a region of correspondence between the field of view 125 and field of reflection 155 of the adjacent mirror 150 and camera 120, the mirror 150 is angled slightly relative to the camera 120. As discussed above, the areas of the camera image 121 wherein the field of reflection 155 substantially corresponds to the field of view 125 need not be symmetric nor uniform. The configuration of FIG. 2B is well suited for an environment having a limited range, such as within a room or studio, and wherein the correspondence between the fields 125, 155 is more important at the top of the image 121 than at the bottom. If the target person (not shown) can see his or her reflection in the mirror image 151, including the top of his or her head, the target person can be reasonably assured that the camera image 121 will contain the top of his or her head. The target person in this example, however, would not necessarily know how much of his or her lower body will be contained in the image 121. As would be evident to one of ordinary skill in the art, if a closer correspondence between the field of view 125 and field of reflection 155 is desired, a curved mirror 150 as illustrated in FIGS. 1 and 2A can be used. As illustrated in FIG. 2B, having the camera 120 adjacent the mirror 150 obviates the need for a transparent area 158 within the mirror surface, or the need for a one-way mirror 150′. As such, the example embodiment of FIG. 2B is preferred for minimal cost applications, requiring only a conventional mirror 150 and means for affixing it relative to the camera 150.

FIG. 2C illustrates an example embodiment of a stereoscopic image framing system in accordance with this invention. A mirror 150 is mounted between two cameras, 120A and 120B, having fields of view 125A and 125B, respectively. The mirror 150 is illustrated as being slightly curved, although a flat mirror could be used in a less costly embodiment. Stereoscopic cameras provide for three-dimensional imaging, and allows for a determination of the distance, or depth, of an image object from the camera. In order for the image object to appear in three dimensions, or for the depth of the image object to be determined, the image object must be within the field of view of both cameras 120A, 120B. The region that is included in both fields of view 125A, 125B is illustrated as the stereo field of view 125′ in FIG. 2C. In the example embodiment of FIG. 2C, the field of reflection 155 of the mirror 150 is structured to correspond substantially to the stereo field of view 125′ of the stereoscopic arrangement of cameras 120A and 120B.

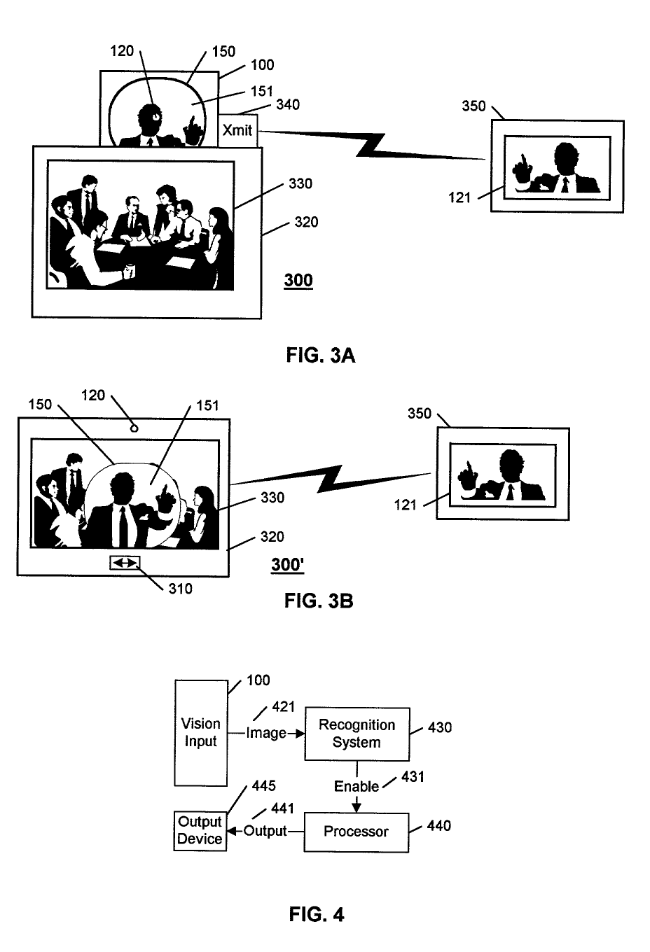

FIGS. 3A and 3B illustrate examples of alternative embodiments 300, 300′ of a video system in accordance with this invention, as might be used, for example, in a video conferencing application. The video system 300, 300′ communicates a camera image 121 from a camera 120 to a remote display device 350 via a transmitter 340. Any number of transmission means may be utilized, including telephone, cable, Internet, satellite, and the like. While the video system 300, 300′ is communicating with the remote display device, a display device 320 that is co-located with the camera 120 displays an image 330 from another camera (not shown) at a remote location, typically co-located with the remote display device 350.

In FIG. 3A, the video system 300 includes an image framing system 100 and the display device 320. The image framing system 100 includes a mirror 150, with the camera 120 located at its center, corresponding to the arrangement illustrated in FIG. 1; other mirror 150 and camera 120 arrangements, such as those illustrated in FIGS. 2A-2C, and others, can be used. In the example of FIG. 3A, the mirror 150 is constructed to reflect a mirror image 151 that is representative of the camera image 121 at the remote display device 350. If a user of the video system 300 sees his or her reflection in the mirror 150, he or she can be reasonably confident that a very similar image 121 is being displayed at the remote display device 350. As would be evident to one of ordinary skill in the art, the size and placement of the image framing system 100 relative to the display device 320 may vary, depending upon the expected use of the system. If the user is expected to be within a few feet of the mirror 150, the mirror 150 can be small, and would allow, for example, a placement of the camera 120 and mirror 150 within the enclosure of the display device 350. If the user is expected to be a substantial distance from the mirror 150, the mirror 150 should be large enough to allow the user to discern the reflected image sufficiently to determine whether a change of position is required for proper framing. In a preferred embodiment, the orientation of the display device 350 and the image framing system 100 are independent, allowing, for example, a rotation of the image framing system 100 for views of different areas of a large conference room. In accordance with this invention, the use of an image framing system 100 saves the cost, power, and space requirements of a second display device, or a picture-in-picture capability within the display device 350, as typically required for framing images in a conventional teleconferencing system.

The aforementioned elimination of the need for a display device for framing an image is particularly well suited to “one way” video applications. The reduced size and reduced power of an image framing system 100 in accordance with this invention, compared to a conventional video feedback device, for example, allows for an embodiment of this invention into wearable consumer devices, such as watches, pendants, and the like. A user can transmit a message, with attached still or motion images of the user, to personalize or authenticate the message when it is received at a remote location. For example, a parent can communicate a message to a home computer system, for later viewing by the parent's children. In like manner, a news reporter who is traveling without a camera crew can communicate a news report, with still or motion images of the reporter providing the report. In another application in accordance with this invention, a user can send an e-mail message, with attached still or motion images, from a PDA or portable telephone. In each of these applications, the use of a reflective image not only facilitates the proper framing of the user within the camera image, it also provides a potential improvement in comfort-level during use, as compared to looking and speaking into, for example, a blank watch face or PDA screen.

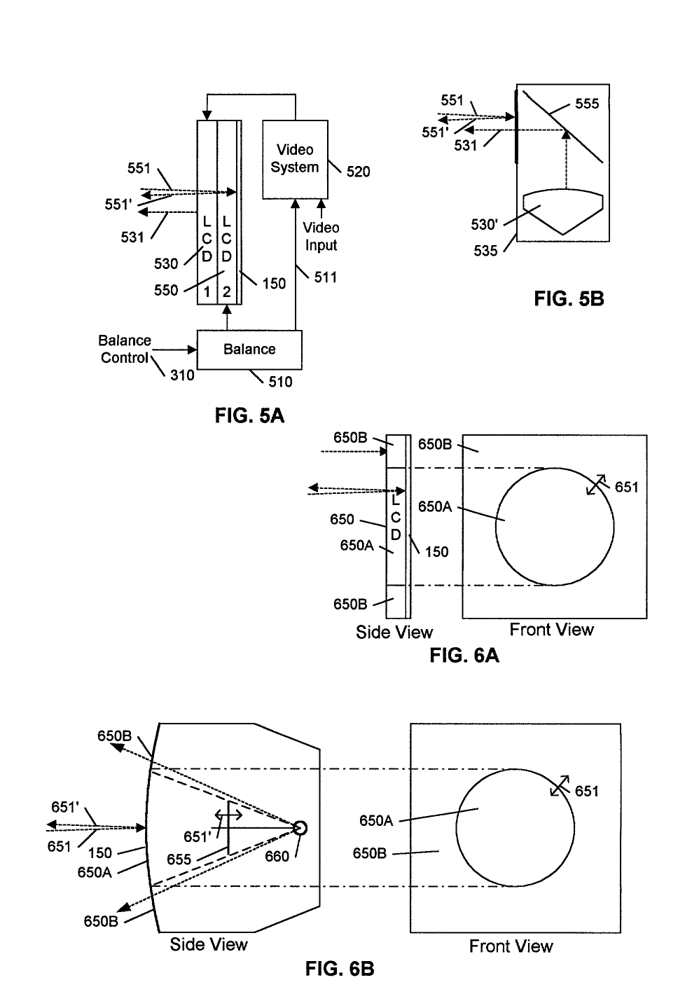

In FIG. 3B, the video system 300′ includes an image framing system that is integrated within the display device 320. In accordance with this aspect of the invention, the display device 320 includes a mirror element 150 that provides a reflected mirror image 151 that overlays the image 330 from another camera. The reflected mirror image 151 provides a representation of the camera image 121 that is produced by the camera 120 in FIG. 3C. In this embodiment, because the mirror element 150 is integrated with the display device 320, the camera 120 is structured so as to have a field of view (not shown) that substantially corresponds with the field of reflection (not shown) that is provided by the integrated mirror element 150. In a preferred embodiment, the integrated system 300′ includes a balance control 310 that adjusts the mix of the displayed image 330 and the reflected image 151, and is discussed further with regard to FIGS. 5A and 5B.

As would be evident to one of ordinary skill in the art, the display device 320 is not restricted to the display of video images from another camera. The display device 320 may be, for example, a text-only display, or a graphics display such as used in hand-held video games. Gaze-based based control systems are becoming increasingly popular, wherein, for example, the mouse pointer is controlled by looking, or gazing, at different items on the display. Such control systems typically require the capture of light reflected from the user's eyes; in the context of this invention, the device used to capture this light is a camera 120. The image framing system 100, as discussed above, provides a low cost system with which a user can immediately determine whether his or her eyes are in the field of view of the camera 120 in the control system of such a gaze-based system or interface.

The image framing system 100 may be used in other applications as well. FIG. 4 illustrates an example embodiment that includes a recognition system 430, as may be included, for example, in a PDA (Personal Data Assistant) device. As PDAs become increasingly popular, the “personal” nature of these personal data assistants will become increasingly important for product differentiation and product appeal. A preferred embodiment of an image framing system 100 in this application is a compact-mirror PDA device that fits in a person's pocket or purse. To activate the device, to obtain, for example, the person's next appointment, the person looks into the mirror. When the person's image is framed in the mirror, the recognition system 430 recognizes the person and enables 431 a processor 440 to provide an output 441 to an output device 445, such as a speaker or display. The use of the image framing system 100 in this application provides an additional degree of privacy and security, and the use of a mirror system adds a degree of personalization to the Personal Data Assistant device.

A system as illustrated in FIG. 4 will also be useful in a multi-user environment, for example, as a mirrored-notepad on an appliance such as a television or refrigerator. When a user views his or her image in the mirrored-notepad, the recognition system 430 determines which user is present, and enables 431 the processor 440 to provide the output 441 appropriate to this particular user. In a preferred embodiment, the processor 440 includes a messaging system that allows for multiple user and single user addresses for each message. A parent, for example, may leave a message addressed to all household members, and a separate message addressed to a particular child. The output 441 may also include the image 421 that was presented when each message was recorded. These and other applications of a video system that benefits from an image framing system 100 will be apparent to one of ordinary skill in the art.

FIGS. 5A and 5B illustrate examples of alternative embodiments of an image framing system that is integrated within a display device. The camera of the image framing system of FIGS. 5A and 5B is not illustrated, because it can be located in a variety of configurations with respect to the mirror 150, as illustrated, for example, in FIGS. 1, 2A, 2B, 2C. In each of the embodiments of FIGS. 5A and 5B, the mirror 150, 150′ may be a one-way mirror, a mirror with a transparent center area, a conventional mirror with the camera adjacent, and so on.

The embodiment of FIG. 5A includes a video system 520 that produces a received video image on a first LCD 530. This LCD 530, for example, displays the image 330 from a remote camera, as in FIGS. 3A and 3B. A second LCD 550 is provided as a shutter to the mirror 150. The LCD 550 is controlled by a balance device 510 that determines the state of the LCD 550. In a mirror state, the second LCD 550 allows light to pass through its polarized crystalline structure.

The balance device 510 also provides a control signal 511 to the video system 520 to place the first LCD 530 in a transparent mode during this mirror state. In the mirror state, therefore, any light that enters the 530-550 structure is reflected by the mirror 150, as illustrated by the dashed arrows 551, 551′. The mirror state can be reduced or eliminated by the balance device 510 by increasing the opacity of the second LCD 550, and de-asserting the control signal 511 to the video system 520. With an opaque background, the first LCD 530 operates in conjunction with the video system 520 in the conventional manner, conveying images or text, as indicated by the dashed arrow 531 in FIG. 5A. A balance control, such as the control 310 illustrated in FIG. 3B, determines the degree of reflection, and thus provides an adjustable balance between the intensity of reflected image 151 from the LCD-mirror combination, as compared to the displayed image 330 from the first LCD 530.

FIG. 5B illustrates an example embodiment that uses an emissive display, such as a cathode ray tube as used in a conventional television or computer monitor. A lightly silvered mirror 150′ is used to provide a conditional one-way property. If the area behind the mirror 150′, within the enclosure 535, is dark, the mirror 150′ reflects light, as illustrated by the arrows 551, 551′ in FIG. 5B. If the area behind the mirror 150′ is illuminated, the emitted light 531 overcomes the reflective effect of the lightly silvered mirror 150′. As in FIG. 5A, a balance device is used to 10 determine the intensity of the display device 530′, and thus the intensity of the mirrored image from the mirror 150′. In a preferred embodiment, when the display device 530′ is dimmed, the reflected image from the mirror 150′ will be immediately apparent; when the display device 530′ is set to normal viewing intensity, the reflected image from the mirror 150′ will be not be discernable.

The embodiments presented thus far have assumed a fixed field of view 125 associated with the camera 120. However, the invention presented herein is not limited to fixed field cameras. As noted above, the field of reflection 155 of the mirror 150 need not correspond exactly to the field of view 125 of the camera 120. In a straightforward embodiment of this invention for a camera 120 having a variable field of view 125, the field of reflection 155 of the mirror 150 is structured to substantially correspond to the camera's field of view for all of the views. That is, the mirror's field of reflection 155 is structured to substantially correspond to the camera's narrowest field of view, and will thus correspond to the other fields of view in the center area of the camera image 121. In a preferred embodiment, however, the mirror's field of reflection 155 is structured to change as the camera's field of view 125 changes.

FIGS. 6A and 6B illustrate example embodiments of an image framing system for cameras with variable fields of view. As in the previous figures, the camera is not illustrated in these figures because it can be situated in any one of a variety of locations, as discussed above. FIGS. 6A and 6B illustrate example embodiments for producing a variable field of reflection. In FIG. 6A, an LCD 650 is placed in front of a mirror surface 150. As discussed with regard to FIG. 5A, an LCD can be controlled using conventional techniques to produce varying degrees of opacity through its crystalline structure. In the example of FIG. 6A, one region 650A of the LCD 650 is controlled so as to be transparent, and the remaining area 650B is controlled so as to be opaque. Because of the mirror 150, light 651 that enters the transparent area 650A is reflected 651′, whereas light 652 that enters the opaque area 650B is not reflected. By controlling the areas of opacity and transparency of the LCD 650, the size of the reflective area, and thus the size of the field of reflection, can be adjusted, as illustrated by the arrow 651 in FIG. 6A. In accordance with this invention, a controller (not shown) controls the size of the reflective area 650A in dependence upon the field of view of a variable field camera 120 associated with the mirror 150.

FIG. 6B is an embodiment of a light box having a variable sized umbra, or shadow area, in its center area. A light source 660 emits light; an obstacle 665 blocks the light from reaching the center area 650 of a lightly silvered mirror surface 150. Outside 650B the center area 650A, the light from the light source 660 passes through the lightly silvered mirror surface 150 and overcomes the reflective qualities of the mirror surface 150. Thus, viewed from the front, the region 650A appears reflective, while the region 650B is not reflective. By adjusting 651′ the location or size of the obstacle 665, the size of the reflective area 650A, and thus the size of its reflective field, can be changed. As would be evident to one of ordinary skill in the art, other means of adjusting a shadow size are common, such as via the use of an iris structure that changes the diameter of the obstacle 665. As in FIG. 6A, a controller (not shown) controls the size of the reflective area 650A in dependence upon the field of view of a variable field camera 120 associated with the mirror 150.

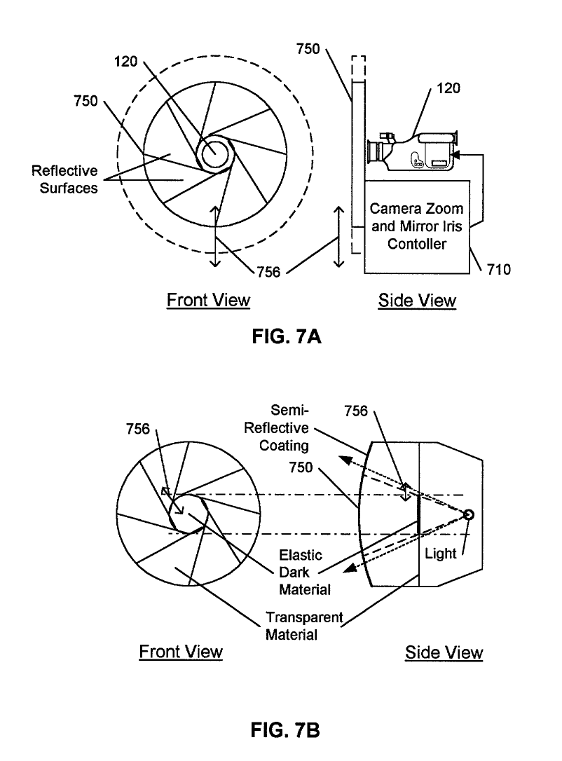

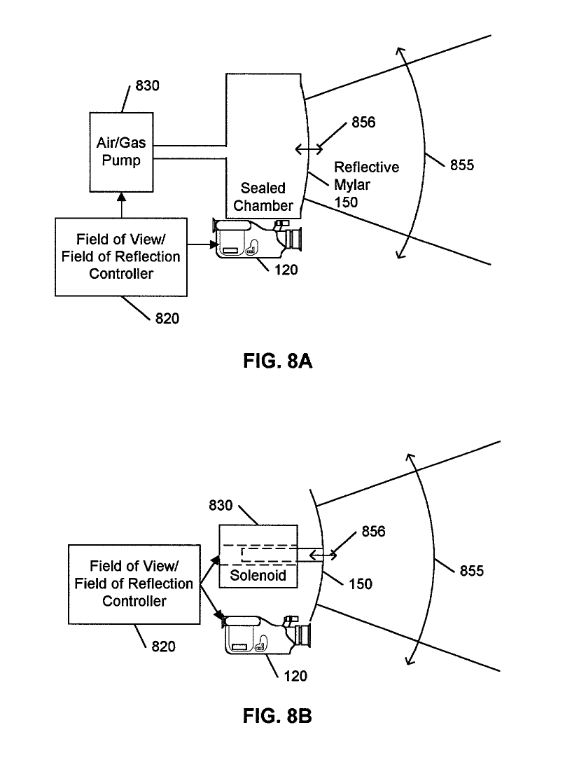

The foregoing merely illustrates the principles of the invention. It will thus be appreciated that those skilled in the art will be able to devise various arrangements which, although not explicitly described or shown herein, embody the principles of the invention and are thus within its spirit and scope. For example, to adjust the size of the field of reflection to correspond to an adjustable field of view of a camera, a reflective iris structure 750 can be provided that changes its radius 756 in dependence upon the camera's field of view, as illustrated in FIGS. 7A and 7B. The controller 710 adjusts the zoom factor of the camera 120 to provide narrow or wide fields of view, and simultaneous adjusts the radius 756 to correspond to the selected field of view. In a similar manner, as illustrated in FIGS. 8A and 8B, the mirror's field of reflection 855 can be modified by changing its radius of curvature 856, using for example a mirrored diaphragm surface 150 can be controllably 820 flexed 830 to correspond to the field of view of the camera 120. These and other mechanical arrangements for providing a correspondence between a camera's field view and a mirror's field of reflection will be evident to one of ordinary skill in the art, and within intended scope of the following claims.

We claim:

1. An image framing system comprising:
a camera that produces a camera image, and
a mirror that produces a mirror image,
wherein:
the mirror is operably coupled to the camera such that the mirror image is representative of the camera image so as to facilitate framing an object image in the camera image.

2. The image framing system of claim 1, wherein:
the camera has a first field of view, and
the mirror has a field of reflection that substantially corresponds to the first field of view of at least a portion of the camera image.

3. The image framing system of claim 2, further including
a second camera that has a second field of view that in conjunction with the first field of view forms a stereo field of view, and
wherein the field of reflection also substantially corresponds to the second field of view and the stereo field of view in at least a portion of the camera image.

4. The image framing system of claim 1, wherein:
the mirror has a front surface that is substantially reflective and a rear surface, and
the camera is located behind the rear surface.

5. The image framing system of claim 1, also comprising
an output device having a display area for displaying a second image,
wherein the mirror is located within the display area.

6. The image framing system of claim 1, wherein the mirror has a front surface that is substantially reflective, and the image framing system also includes:
a controllable device that controls a field of reflection that is associated with the mirror.

7. The image framing system of claim 1, further including
a light source that emits light, and
wherein the mirror provides the mirror image in dependence upon the light.

8. The image framing system of claim 1, further including:
a recognition device, operably coupled to the camera, that provides an enable signal in dependence upon the camera image, and,
a processing system, operably coupled to the recognition device, that provides an output in dependence upon the enable signal.

9. The image framing system of claim 1, wherein the image framing system is included in at least one of: a wearable device, a watch, a telephone, a computing device, and an appliance.

10. The image framing system of claim 1, wherein the camera image is communicated to a remote location for subsequent viewing.

11. A video conferencing system comprising:
an image framing system that includes:
a camera that produces a camera image for communication to a remote site, and
a mirror that produces a mirror image that is representative of the camera image to facilitate framing an object image in the camera image; and,
a display system that displays a second image received from the remote site.

12. The video conferencing system of claim 11, wherein
the display system includes a display area for displaying the second image, and
the mirror is located within the display area.

13. The video conferencing system of claim 11, wherein:
the camera has a field of view, and
the mirror has a field of reflection that substantially corresponds to the field of view of the camera of at least a portion of the camera image.

14. The video conferencing system of claim 11, further including:
a transmitter that communicates the camera image to the remote site.

15. An image transmission system comprising:
camera that produces a camera image,
mirror, operably coupled to the camera that produces a mirror image that corresponds substantially to the camera image, and
transmitter, operably coupled to the camera, that transmits the camera image to a remote

16. The image transmission system of claim 15, further comprising at least one of: a computing device, telephone, a PDA, a voice transmitter, a text transmitter, and an e-mail transmitter.

17. The image transmission system of claim 15, wherein the transmitter transmits the camera image via at least one of a telephone system, a cable system, a wireless system, and an Internet system.

18. A method of framing an image of an object within a camera image comprising the steps of:
aligning a mirror so as to provide a mirror image that is representative of the camera image, and
adjusting a position of the object in dependence upon the mirror image and thereby frame the image of the object in the camera image.

19. The method of claim 18, further including the step of:
adjusting a field of reflection of the mirror in dependence upon a field of view associated with the camera image.

20. The method of claim 18, further including the step of transmitting the camera image to a remote location.
